(19) United States
(12) Patent Application Publication
(10) Pub. No.: US 2016/0358502 A1
(43) Pub. Date: Dec. 8, 2016

(54) PORTABLE POSTURE CORRECTION AND ENFORCEMENT DEVICE

(71) Applicants: Elaine Lu, San Jose, CA (US); Robert Huang, San Jose, CA (US)

(72) Inventors: Elaine Lu, San Jose, CA (US); Robert Huang, San Jose, CA (US)

(21) Appl. No.: 15/174,950

(22) Filed: Jun. 6, 2016

Related U.S. Application Data
(60) Provisional application No. 62/172,236, filed on Jun. 8, 2015.

(51) Int. Cl. G09B 19/00

(52) U.S. Cl. CPC G09B 19/00

(57) ABSTRACT

A portable posture correction and enforcement device is provided for aligning a user at a sitting workspace. The device includes a distance bar and an attachment mechanism coupled to one end of the distance bar, the attachment mechanism to removably couple the distance bar to the workspace. The portable posture correction and enforcement device further may include a horizontal bar coupled to the distance bar, the horizontal bar providing additional guidance to the user on a horizontal plane, and a timer coupled to the distance bar and the attachment mechanism, the timer configured to provide timing for training for improving posture of the user.

### CROSS-REFERENCE TO RELATED APPLICATIONS

This application claims the benefit of U.S. Provisional Application No. 62/172,236, filed Jun. 8, 2015, which is hereby incorporated by reference.

### TECHNICAL FIELD

Embodiments of the invention relate to the field of ergonomics; and more specifically, to aides for improving posture while sitting and working at a workspace such as at a desk or table or with an electronic device.

### BACKGROUND

Good sitting posture is extremely important while working and during studies, especially for children. Scientific reports and studies have identified the importance of correct sitting posture. These reports have set forth that when the spine is not balanced, inevitably there are problems with the back, neck and shoulders as well as the joints. Thus, these problems can be avoided if correct posture can be maintained.

Further studies have found that subjects who were told to sit up straight with good posture gave themselves higher ratings and had more self-confidence on a given task than those who were told to slouch. Sitting straight helps people remain alert. A straight spine is very helpful in keeping the free flow of energy through your chakras. Also, such studies indicate keeping a straight spine also helps concentration.

In addition, news reports and studies relate that reading under various conditions can affect vision. Some reports indicate that reading in the dark or holding a book too close to your face could damage the eyes of the reader. It is often that people start or are taught the correct sitting posture and/or appropriate reading, writing or drawing distances. After a while, however, many people forget or lose the habit of utilizing their correct sitting posture or reading, writing or drawing distances. Instead, these people will sit slouched and read, write or draw too closely to their workspace (i.e., they lose their proper reading and writing distances). Learning or relearning proper posture can require specialized training or aides that are not readily available or are cost prohibitive.

### SUMMARY

The embodiments of the invention present a portable posture correction and enforcement device for users when they are in a sitting position (e.g., at a desk or table) to encourage maintenance of the correct sitting posture, keeping the right reading distance and increasing concentration.

In accordance with the embodiments of the invention, a portable posture correction and enforcement device is provided to be utilized when the user is in a sitting position to remind, train and/or encourage the user to maintain the correct sitting posture, keep the right reading distance and focus. In an embodiment of this invention, the portable posture correction and enforcement device includes one or more elements that service as distance bars to keep a user who is in a sitting position at the right distance between their head and the desk, table or similar surface. The portable posture correction and enforcement device can be placed between the user and the desk, table, computer, laptop, tablet or similar surface or electronic device, therefore the device will serve as a reminder and/or a training aide to help the user to maintain the proper sitting posture and keep the correct reading distance. The portable posture correction and enforcement device can include a set of distance bars and support structures. A ‘set,’ as used herein refers to any positive whole number of items, including one item. The distances bars or support structures may include one or more attachment devices that support the portable posture correction and enforcement device on the surface of the workspace or attach the portable posture correction and enforcement device to the workspace (e.g., a desk, table, computer, tablet, laptop or similar device or surface).

### BRIEF DESCRIPTION OF THE DRAWINGS

The embodiments of the invention are illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a first example embodiment of a portable posture correction and enforcement device.

FIG. 2 is a second example embodiment of a portable posture correction and enforcement device.

FIG. 3 is a third example embodiment of a portable posture correction and enforcement device.

FIG. 4 is a fourth example embodiment of a portable posture correction and enforcement device.

FIG. 5 is a fifth example embodiment of a portable posture correction and enforcement device.

FIG. 6 is a sixth example embodiment of a portable posture correction and enforcement device.

FIG. 7 is a seventh example embodiment of a portable posture correction and enforcement device.

FIG. 8 is a diagram of one example embodiment of the portable posture correction and enforcement device in a work environment.

### DETAILED DESCRIPTION

In one embodiment, a portable posture correction and enforcement device, herein after simply the portable posture correction and enforcement device, is provided for aligning a user at a sitting workspace by blocking the view of the user toward the workspace of a table, desk or electronic device, physically maintaining the distance between the head and the workspace, or reminding the user of the proper distance and/or posture. The apparatus includes a distance bar that has a height that provides a line of sight guide to a user when positioned on a surface of a workspace, the height and line of sight requiring a user seated at the workspace to maintain correct posture to have unblocked line of sight to the workspace or to provide a reminder of the correct distance between the head of the user and the workspace for proper focus and/or posture, and an attachment mechanism coupled to one end of the distance bar, where the attachment mechanism is designed to removably couple the portable posture correction and enforcement device to the workspace. The portable posture correction and enforcement device further may include a horizontal bar coupled to the distance bar, the horizontal bar providing additional line of sight guidance to the user on a horizontal plane and/or a physical mechanism by which the head of the user is properly positioned relative to the workspace. The horizontal bar is positioned at the height of the line of sight guide or to correctly position the head. In some embodiments, a timer is coupled to the distance bar, horizontal bar, or the attachment mechanism. The timer may be configured to provide timing for training for improving posture of the user by maintaining the line of sight or head position relative to the workspace. In some embodiments, the horizontal bar and/or distance bar are sufficiently rigid and/or soft to hold the weight of the user, such as the weight of the head of the user, for example by allowing the chin of the user to rest on the horizontal bar or similarly serve to guide the position of the user. In other examples, the horizontal bar helps remind the user to maintain correct reading or focus distance and/or to maintain proper posture.

The invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following section, in order to provide a thorough understanding of embodiments, the present invention now will be described more details hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein, rather, these embodiments are provided so that this disclosure will be thorough and complete, and will convey the scope of the invention to those skilled in the art.

In the description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

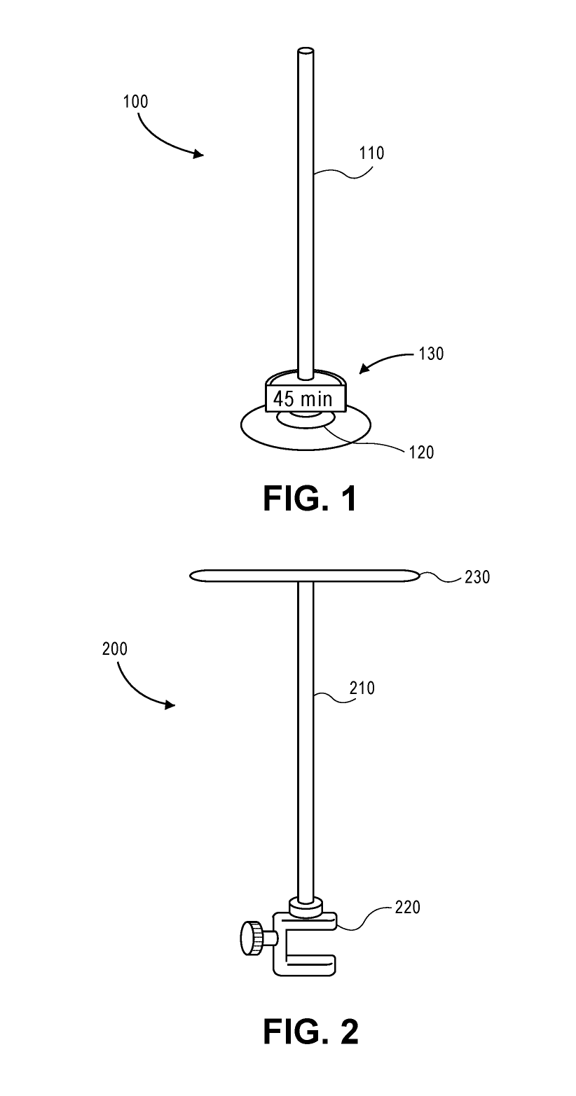

FIG. 1 is a diagram of a first embodiment of the portable posture correction and enforcement device. In FIG. 1 there is shown a portable posture correction and enforcement device 100 having a vertical distance bar 110, and an attachment device 120. The attachment device 120 connects the distance bar and the workspace. As used herein ‘workspace,’ refers to a table, desk, computer, tablet, laptop, book or similar surface or electronic device being viewed by a user. The distance bar 110 and attachment device 120 can have various shapes, configurations and construction consistent with the principles of the invention. The attachment device 120 can be a stand or base to support the portable posture correction and enforcement device, as illustrated, while in other embodiments the attachment device 120 can be a clip-on device, a suction cup, or similar mechanism to make the posture correction and enforcement device removably attach to the workspace such as a desk or table.

The distance bar 110 can be molded or extruded rubber, plastic, metal, fiberglass, ethylene vinyl acetate (EVA), foam, composite or similar material. Materials may be selected to be sufficiently pliable or soft to minimize risk of injury to a user while having sufficient material strength and structure to maintain an upright position roughly perpendicular to the workspace and in some embodiments to hold the weight of the head of the user. The selected materials may have general rigidity and resilience suitable for maintaining its position relative to the surface to which the portable posture correction and enforcement device 100 is attached. The distance bar 110 can be covered in some embodiments in a soft material, such as foam or other cushioning to protect the distance bar 110 from impact and to protect the user if the user inadvertently runs into the distance bar 110 with any part of the body. The distance bar 110 can have any shape or size and is designed in combination with any other supporting structures to provide a guide by which a seated user can judge proper posture by ensuring that the user can see over the distance bar 110 to see the book, screen, or similar workspace thereby training proper posture as the user will not be able to properly view the intended target if slouching or otherwise losing proper posture or serve as a reminder for the correct reading distance.

The attachment device 120 can be coupled to the distance bar 110 using any mechanism or device such as interlocking parts, nut and bolts, screws, adhesives or similar coupling mechanisms. In some embodiments, such as the case where the attachment device 120 is a base or stand, the attachment device 120 may be integrally formed with the distance bar 110 as a singular molded or extruded component or similarly constructed. The attachment device in the illustrated example of FIG. 1 is a base or stand that provides a flat bottom surface to be placed on the surface of the workplace and has sufficient rigidity and structure to hold the distance bar 110 upright at a right angle to the workspace surface to provide the intended distance guide for the distance bar 110.

In some embodiments, the distance bar 110 may encompass an adjustment mechanism to enable the distance bar 110 to be adjustable in height relative to the attachment mechanism 120. The adjustment mechanism (not shown) can be adjustable to any range or granularity in height by the user. The adjustment mechanism can include a slide, hinge, screw, pivot, latch, or any combination thereof that connects the distance bar 110 to the attachment mechanism 120 and thereby enables the relative motion and adjustment of distance between the distance bar 110 and the surface of the workspace. For example, in one embodiment the distance bar 110 of the illustrated embodiment may be slideably attached to an internal rod that is connected to the attachment mechanism 120. The distance bar 110 can be slid to a higher height and locked into place at any height using a latch, clasp, clip or similar integrated or separable mechanism. In embodiments where the adjustment mechanism interfaces with a surface of a workspace anti-slip or similar friction pads or an adhesive may be used on any surface of the device.

In some embodiments, the portable posture correction and enforcement device 100 includes a timer 130. The timer 130 can be attached to any part of the portable posture correction and enforcement device 100 and in some embodiments is detachable. The timer 130 can be utilized as part of the training for the user. Initially, a user may not be able to focus and/or maintain correct posture for an extended period of time. A timer 130 may be utilized to track an amount of time to practice or train focus and correct posture. The user can set the timer for any duration or the timer can include set programs that increase the duration of holding focus or correct posture with each use or over time. The timer 130 can include an alarm and settings to enable the user to be alerted to the end of a timing and to configure the duration and frequency of the alarms. In some embodiments, the timer 130 can include a controller that adjusts the position of the distance bar 110 over time relative to the attachment mechanism 120. The timer can include a display to view the current time and to configure the settings. In other embodiments, no display is provided and the timer 130 includes speakers to emit audio queues in lieu of or in combination with visual cues.

FIG. 2 is a diagram of a second embodiment of the portable posture correction and enforcement device. Referring to FIG. 2, in this second embodiment, there is shown a posture correction and enforcement device 200, where on top of the distance bar 210, there is a horizontal bar 230. The distance bar 210, attachment mechanism 220 and horizontal bar 230 can be any shape or size and the distance bar 210 can connect with horizontal bar 230 at any part of the horizontal bar 230, such as at the center of the horizontal bar, at the side of the horizontal bar or at the end of horizontal bar. The horizontal bar 230 can provide a wider reference point for aligning the posture and line of vision for a user when viewing a workspace. The horizontal bar 230 can be composed of plastics, metals, fiberglass, foam, rubber, composites, and similar materials such as those discussed herein above with regard to the distance bar. In some embodiments, the horizontal bar 230 can be coated or covered in a softer material to avoid damage or injury to a user. The covering material can be a cushion such a foam, fabric, rubber, or similar materials suitable to protect the horizontal bar from damage and the user from injury. In other embodiments, the base materials are composed of soft materials such as foam rubber that is sufficiently soft that a covering material is not utilized.

In this example embodiment, the attachment mechanism 220 can be a clamp, clip, or similar mechanism that supports the posture correction and enforcement device 200 by gripping an edge or similar portion of a workspace. Whereas in other embodiments the attachment mechanism 200 can be a clip-on device or a suction cup to make the posture correction and enforcement device 200 attach to the desk or table. In the illustrated example, a c-clamp is shown that includes a screw/bolt mechanism that enables the user to lock the c-clamp onto the edge of a table or similar surface with the opposing sides of the clamp that can be locked in this position by the screw/bolt mechanism. This embodiment can include a spring load in the clamp to improve the grip and bias the clamp toward a closed position.

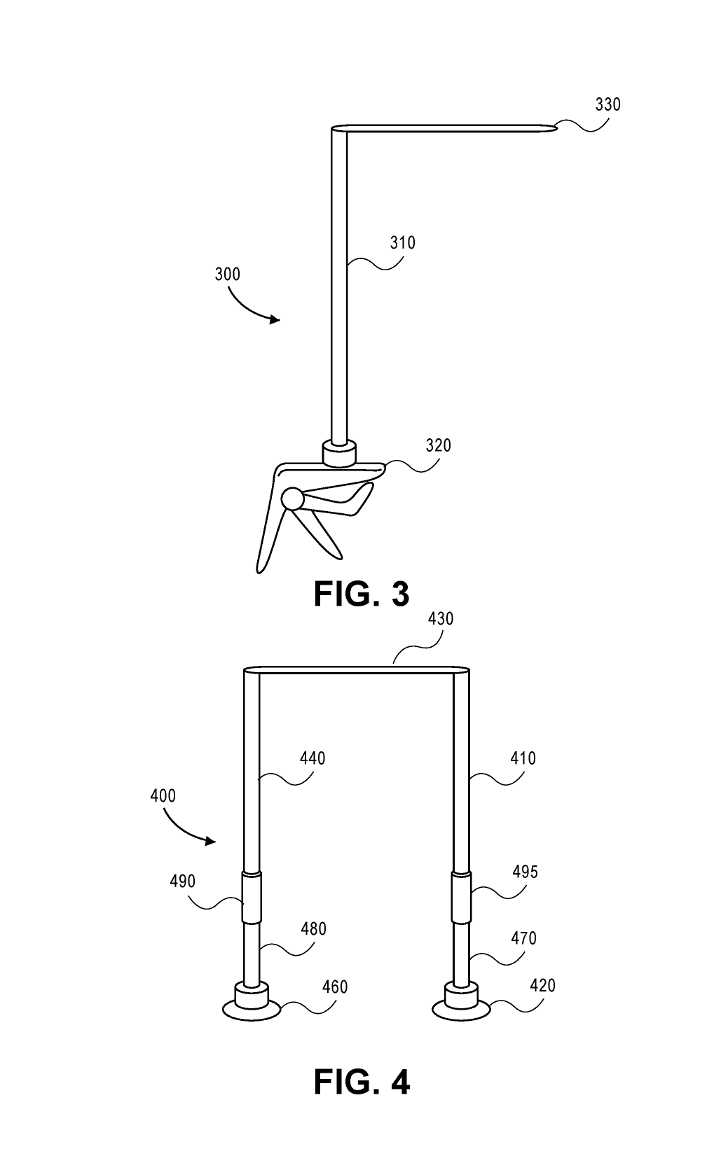

FIG. 3 is a diagram of a third embodiment of the portable posture correction and enforcement device. Referring to FIG. 3, there is shown a third embodiment of the posture correction and enforcement device 300, in this embodiment on top of the distance bar 310, there is a horizontal bar 330. The distance bar 310, attachment mechanism 320 and horizontal bar 330 can have any shapes, material or structure that enables the distance bar 310 and horizontal bar 330 to provide a proper guide for posture a reading. In some embodiments, the horizontal bar and/or distance bar are sufficiently rigid and/or soft to hold the weight of the user, for example by allowing the chin of the user to rest on the horizontal bar or similarly serve to guide the position of the user. The distance bar 310 can connect with horizontal bar 330 at any point along the length of the horizontal bar 330. The distance bar 310 can connect at the center of the horizontal bar 330 or at either end of the horizontal bar 330 (as illustrated in FIG. 3). The attachment mechanism 320 can be a clamp with a tension coil to bias the clamp to a closed position and firmly grip a desktop or table top workspace. In other embodiments, the attachment mechanism 320 can be a stand to support the portable posture correction and enforcement device 300, or it can be a clip-on mechanism or a suction cup to make the portable posture correction and enforcement device removably attach to the desk or table.

FIG. 4 is a diagram of a fourth embodiment of the portable posture correction and enforcement device. Referring to FIG. 4, there is shown a portable posture correction and enforcement device 400, in this embodiment, there are two distance bars 410 and 440 to support horizontal bar 430. The distance bars 410 and 440, attachments mechanisms 420 and 460 and the horizontal bar 430 can have any construction, material or shape with sufficient rigidity and material strength to maintain an upright position on a workspace surface. The distance bars 410 and 440 can connect with horizontal bar 430 at any part of the horizontal bar, such as at the center of the horizontal bar 430, at the side of the horizontal bar 430 or at the end of horizontal bar 430. The attachments mechanisms 420 and 460 can be stands (as illustrated) to support the portable posture correction and enforcement device 400, or can be clip-on devices or suction cups to make the portable posture correction and enforcement device 400 attach to the desk or table. In some embodiments, where the attachment mechanism 420 and 460 is a stand or set of stands, each stand may have a flat bottom surface. The stands may also include a weight to make each stand bottom heavy and better seated on a flat surface such that air flow or a light impact will not topple the portable posture correction and enforcement device 400.

In this embodiment, the height of the distance bars 410 and 440 may be adjustable by a sliding mechanism or similar mechanism within each distance bar 410 and 440. The sliding mechanism can include a set of interior bars 470 and 480 over which the distance bars 410 and 440 slide. The distance bars 410 and 440 may twist lock into place over the interior bars 470 and 480 with a twist lock mechanism 490 and 495 or similar locking mechanism that holds the distance bars 410 and 440 in place relative to the interior bars 470 and 480.

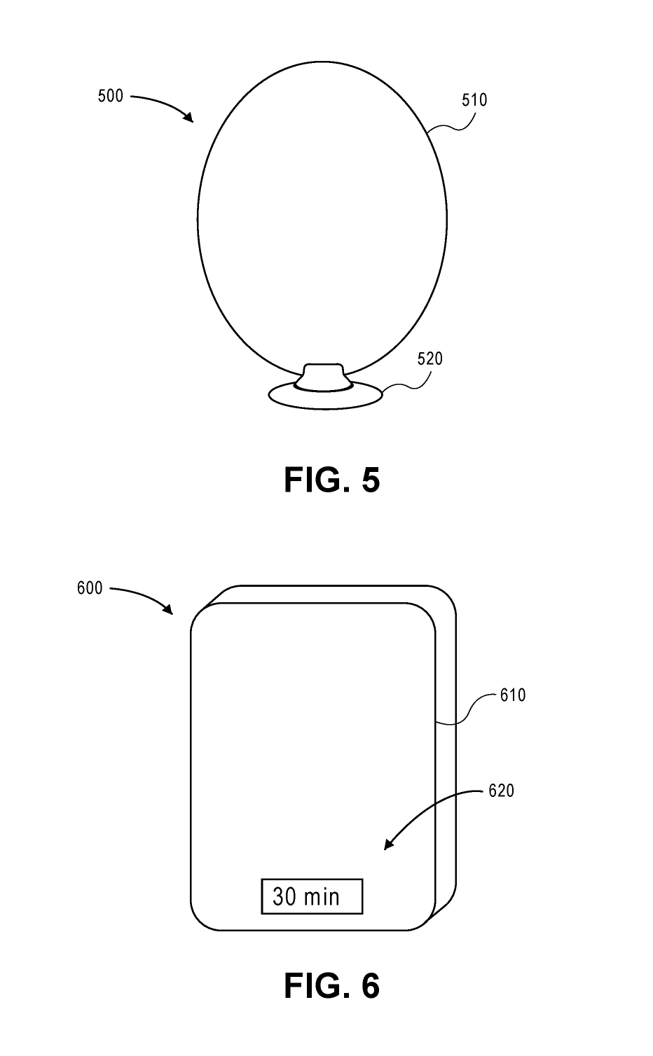

FIG. 5 is a diagram of a fifth embodiment of the portable posture correction and enforcement device. Referring to FIG. 5 there is shown a portable posture correction and enforcement device 500 having an oblong structure 510 that servers as a distance bar. The attachment mechanism 520 connects the oblong 510 (i.e., the distance bar) to the workspace. The oblong structure 510 and attachment mechanism 520 can have any shape, construction, material or form. The oblong shape is provided by way of example, having sufficient height and rounded edges for safety. The attachment mechanism 520 can be a stand (illustrated) to support the portable posture correction and enforcement device 500, it can be a clip-on device, a suction cup, or similar mechanism to enable the posture correction and enforcement device 500 to attach to the desk or table. The oblong structure 510 can have a three dimensional shape or roughly two dimensional (flat) shape. In some embodiments, the oblong structure 510 can have a flat bottom surface and not require a separate attachment mechanism.

FIG. 6 is a diagram of a sixth embodiment of the portable posture correction and enforcement device 600. Referring to FIG. 6 there is shown a portable posture correction and enforcement device 600 having a block 610 that servers as a distance bar, the bottom of the block 610 may connect to or rest directly to the desk or table surface. In other embodiments, the block 610 may include an attachment mechanism (not shown) such as a suction cup or similar mechanism that is hidden beneath the block 610. The block 610 can be formed of the same materials as the described distance bars or horizontal bars. In other embodiments, the block 610 can be formed of any material of sufficient rigidity to stand upright and maintain position while not offering sharp or hazardous edges or surfaces. In some embodiments, the block 610 can bear weight like the horizontal bar. The block 610 can be weighted at the bottom to bias the block 610 to an upright position that serves as a distance bar and guide for posture and reading focus. The block 610 can be changed to different shapes, including more squared or elongated rectangular shapes as well as pyramidal shapes. Other shapes that have a flat or stable base can also be utilized. The bottom of block 610 can be a stand to support the portable posture correction and enforcement device 600, or it can be a clip-on device or a suction cup to enable the posture correction and enforcement device 600 to attach to the desk or table. In some embodiments, a timer 620 may be embedded into the block 610. The timer 620 can be used in combination with any of the embodiments and the reasonable permutations thereof discussed herein.

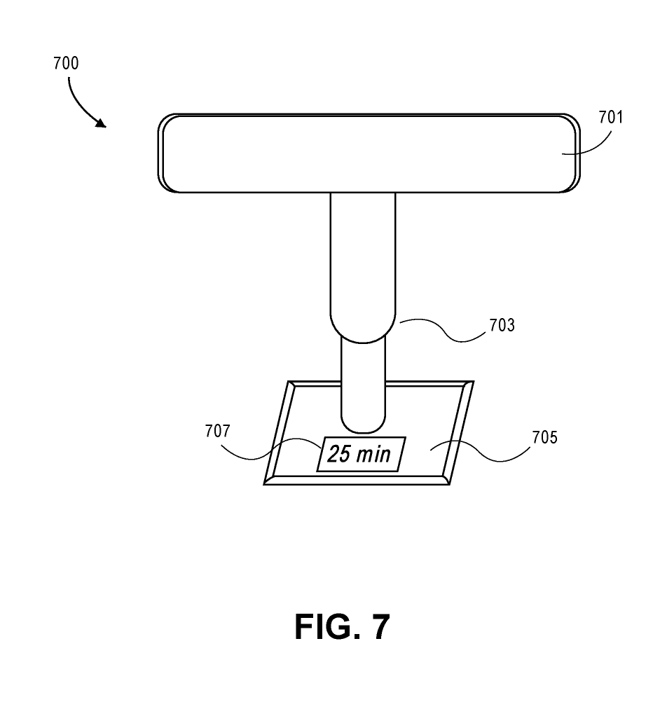

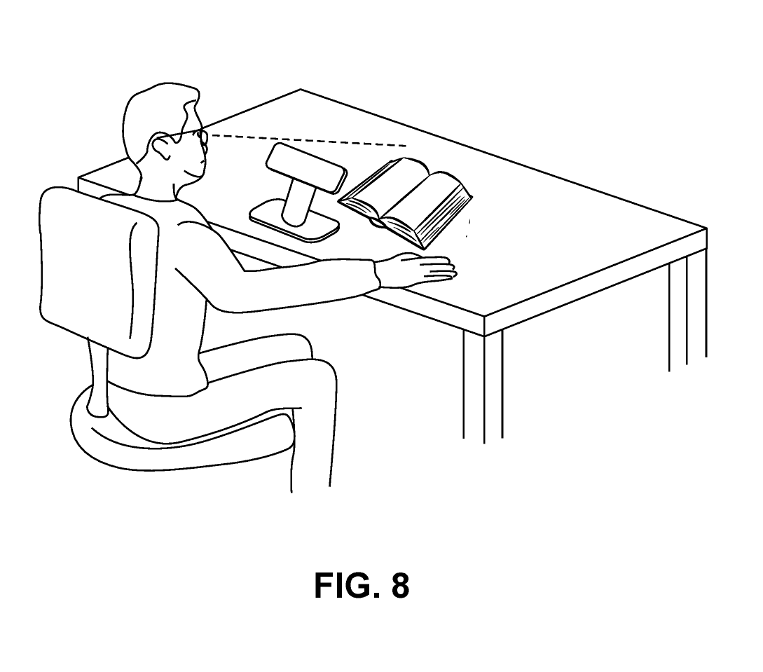

FIG. 7 is a diagram of a seventh embodiment of the portable posture correction and enforcement device 700. Referring to FIG. 7 there is shown a portable posture correction and enforcement device 700 having a set of interlocked/sliding rods 703 that servers as a distance bar, the bottom of the interlocked rods 703 may connect to an attachment mechanism 705 that attaches to or rests directly on the desk or table surface. In other embodiments, the attachment mechanism 705 may include a suction cup, anti-slip pads, adhesives or similar mechanism that is hidden beneath the attachment mechanism 705. The attachment mechanism 705 can be weighted at the bottom to bias the apparatus to an upright position that serves to orient the distance bar 703 and a horizontal bar 701 as a guide for posture and reading focus. In some embodiments, the horizontal bar and/or distance bar are sufficiently rigid and/or soft to hold the weight of the user, such as the weight of the head of the user, for example by allowing the chin of the user to rest on the horizontal bar or similarly serve to guide the position of the user. The distance bar 703 and horizontal bar 701 can be changed to different shapes, including interlocking tubular rods, squared rods or elongated rectangular shapes as well as triangular shapes. The distance bar 703 can be composed of multiple interlocked bars or structures that are configured to slide relative to one another enabling the height of the portable posture correction and enforcement device 700 to be adjusted. The adjustable height can be locked into place by a complementary locking mechanism, by a friction fit, or similar mechanism. Other shapes that have a flat or stable base can also be utilized as the attachment mechanism 705. In other embodiments, the attachment mechanism 705 can be another mechanism to support the portable posture correction and enforcement device 700, it can be a clip-on device or a suction cup to enable the posture correction and enforcement device 700 to attach to the desk or table. In some embodiments, a timer 707 may be embedded into the attachment mechanism 705, distance bar 703 or horizontal bar 701. The timer 707 can be used in combination with any of the embodiments and the reasonable permutations thereof discussed herein. In further embodiments, additional components can be integrally or removable attached to the attachment mechanism 705, distance bar 703 or horizontal bar 701 including a lamp (e.g., light emitting diode (LED) or incandescent bulb), media player, clock, and similar components. Where the components are electronic and require a power source a battery compartment, direct current or alternating current circuits or similar power sources may be included.

In further detail, the construction details of the invention as shown in FIG. 1, FIG. 2, FIG. 3, FIG. 4, FIG. 5, FIG. 6 and FIG. 7 are that the portable posture correction and enforcement devices may be constructed of various molded, extruded, or assembled materials and in various shapes and configurations. The embodiments have been provided by way of illustration and not limitation and one skilled in the art would appreciate the reasonable variations that are consistent with the structure and principles of the described invention. As mentioned above, materials that can be used are generally lightweight consistent with the portability of the device. Rubber, plastics, ethylene vinyl acetate (EVA), foam, fiberglass, metal, composite or similar materials can be used for the basic structure. In some embodiments, the basic structure can be covered in a soft material, such as foam or other cushioning to protect the distance bar 110 from impact and to protect the user if the user inadvertently runs into the distance bar 110 with any part of the body. In other embodiments, the base materials are made of soft materials such as foam rubber that is sufficiently soft that a covering material is not utilized.

Distances bars can be adjustable to change the height of the devices using any type of adjustment mechanism including sliding mechanisms, rotating mechanisms, attachment mechanisms (i.e., to add additional length or components to increase a length of a distance bar) and similar adjustment mechanisms. The attachment mechanisms can be a stand to support the portable posture correction and enforcement device on the desk or table, a clip-on device, clamp, weight, a suction cup, or similar mechanism to enable the portable posture correction and enforcement device to removably attach to the desk, table or similar workspace. Various additional devices or functions can be added to the portable posture correction and enforcement devices, such as a timer, media playback device or a lamp. A lamp can provide light on reading material, keyboard or similar item that a user may be looking at. The lamp can be attached to any part of the portable posture correction and enforcement device, in some cases, removably attached. The lamp can be embedded and angled to a location where reading materials should be positioned consistent with the proper posture of a seated user. Timers, clocks and similar devices can assist a user in training posture by tracking time spent with proper posture. In some embodiments, the portable posture correction and enforcement device may include sensors that detect the position and location of the user to track the time and position of the user when using the device.

One of advantages of the embodiments of the present invention include, without limitation, that it is portable and easy to transport. The portability is based on the small size, with the dimensions generally in the range of one to twelve inches wide, two to sixteen inches tall (adjustable), and half an inch to 12 inches thick. Also, the weight of the device is limited by use of lightweight materials to between 2 ounces and 2 pounds.

FIG. 8 is a diagram of one embodiment of a portable posture correction and enforcement device being utilized in a workspace. In the example, the user is reading a book on a desk. The portable posture correction and enforcement device sits between the user and the book on the desktop. In this example, the portable posture correction and enforcement device has a base that sits on the surface of the desk. The height of the distance bar of the device requires that the user sit up in a correct posture to be able to see the book without obstruction. If the user slouches or does not otherwise maintain correct posture, then the view of the user will be obstructed thereby deterring the user from not maintaining proper posture while using the device. In some embodiments, the user may rest their chin on the horizontal bar to maintain and enforce the proper posture and distance. In further embodiments, the posture correction and enforcement device serves as a reminder to the user of the proper reading distance between the user/reader and the workspace.

While the foregoing written description of the invention enables one of ordinary skill to make and use a set of specific embodiments, those of ordinary skill will understand and appreciate the existence of variations, combinations, and equivalents of the specific embodiments, methods, and examples herein. The invention should therefore not be limited by the above described embodiments, methods, and examples, but by all embodiments and methods within the scope and spirit of the invention as claimed.

Many variations and modifications can be made to the embodiments without substantially departing from the principles of the present invention. All such variations and modifications are intended to be included herein within the scope of the present invention.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A portable posture correction and enforcement device for aligning a user at a sitting workspace by blocking the view of the user toward the workspace of a table or desk, maintaining an orientation and distance to the workspace or providing a reminder of proper reading distance between the user and the workspace, the portable posture correction and enforcement device comprising:
a distance bar that has a height that provides a line of sight guide to a user when positioned on a surface of a workspace, the height and line of sight requiring a user seated at the workspace to maintain correct posture to have unblocked line of sight to the workspace or provide the reminder of proper reading distance between the user and the workspace; and
an attachment mechanism coupled to one end of the distance bar, the attachment mechanism to removably couple the distance bar to the workspace.

2. The portable posture correction and enforcement device of claim 1, further comprising:
a horizontal bar coupled to the distance bar, the horizontal bar providing additional line of sight guidance to the user on a horizontal plane, the horizontal bar positioned at the height of the line of sight guide or at a level between a head of the user and workspace that reminds the user of correct distance and posture.

3. The portable posture correction and enforcement device of claim 1, further comprising:
a timer coupled to any one the distance bar or the attachment mechanism, the timer configured to providing timing for training for improving posture of the user by maintaining the line of sight to the workspace.

4. The portable posture correction and enforcement device claim 1, further comprising:
an adjustment mechanism to enable the adjustment of the distance bar height relative to the attachment mechanism.

5. The portable posture correction and enforcement device of claim 4, further comprising:
a locking mechanism to lock the distance bar into a particular adjusted height.

6. The portable posture correction and enforcement device of claim 1, wherein the distance bar is a set of distance bars each attached to the horizontal bar.

7. The portable posture correction and enforcement device of claim 1, wherein the distance bar is any one of a circular or oblong structure, a block, a pyramid or a bar.

8. The portable posture correction and enforcement device of claim 1, wherein the attachment mechanism is any one of a stand, a weighted stand, a suction cup, a clamp, or a clip.

9. The portable posture correction and enforcement device of claim 1, wherein the distance bar is formed from a plastic, metal, ethylene vinyl acetated, foam, or rubber.

10. The portable posture correction and enforcement device of claim 2, wherein the horizontal bar is connected to the distance bar at a first end of the horizontal bar, a middle of the horizontal bar, or at a first end of the distance bar.

11. The portable posture correction and enforcement device of claim 1, wherein the distance bar is covered in a protective material including anyone one of fabric, foam, rubber or plastic.

12. The portable posture correction and enforcement device of claim 2, wherein the horizontal bar is formed from a plastic, metal, ethylene vinyl acetated, foam, or rubber.

13. The portable posture correction and enforcement device of claim 2, wherein the horizontal bar is covered in a protective material including anyone one of fabric, foam, rubber or plastic.

14. The portable posture correction and enforcement device of claim 1, further comprising:
a lamp, clock or media player coupled to any one of the distance bar or attachment mechanism.
